(19) United States
(12) Patent Application Publication
(10) Pub. No.: US 2021/0258203 A1
(43) Pub. Date: Aug. 19, 2021

(54) MISSING ALERT HANDLING SYSTEM AND MISSING ALERT HANDLING METHOD

(71) Applicant: Nippon Telegraph and Telephone Corporation, Tokyo (JP)

(72) Inventors: Takeshi SEKI, Tokyo (JP); Yuichiro IKUMA, Tokyo (JP); Takafumi FUKATANI, Tokyo (JP)

(21) Appl. No.: 17/252,202

(22) PCT Filed: Jun. 7, 2019
(86) PCT No.: PCT/JP2019/022798

§ 371 Date: Dec. 14, 2020

(30) Foreign Application Priority Data
Jun. 15, 2018 (JP) 2018-114700

(51) Int. Cl. H04L 12/24

(52) U.S. Cl. CPC H04L 41/0654; H04L 41/069

(57) ABSTRACT

[Problem] To propose a highly accurate scheme for addressing lost alarms.

[Solution] A lost alarm addressing system includes communication devices (11) configured to transmit an alarm to a management device (20) and transmit a number-of-alarms notification for notifying the number of transmitted alarms to the management device (20), and the management device (20) configured to count the number of alarms received from each of the communication devices (11), collate the counted number of alarms with the number of alarms notified using the number-of-alarms notification, and cause the communication device (11) to retransmit a lost alarm when the two numbers of alarms do not match. Further, the management device (20), when the management device (20) does not receive the number-of-alarms notification within a predetermined time after receiving the alarm from the communication device (11), causes the communication device (11) to retransmit the lost number-of-alarms notification.

### TECHNICAL FIELD

The present invention relates to a lost alarm addressing system and a lost alarm addressing method.

### BACKGROUND ART

An operation system (OpS) collects an alarm transmitted from a network device that is a monitoring target and enables a network manager to recognize an abnormality in a network device or a line based on the alarm. Here, the alarm may be lost during propagation in a network. The loss of the alarm delays an initial operation of failure recovery by the network manager and, as a result, increases a recovery time. Therefore, a system that addresses loss of an alarm is proposed.

For example, Patent Literature 1 describes a transmission device that adds sequence number information for detecting loss, duplication, or order change of frames to a packet signal. Patent Literature 2 describes a device monitoring system that can prevent loss of alarm information by an equipment monitoring device in operation temporarily storing alarm information in place of an equipment monitoring device not in operation.

### CITATION LIST

### Patent Literature

Patent Literature 1: Japanese Unexamined Patent Application Publication No. 2005-244470
Patent Literature 2: Japanese Unexamined Patent Application Publication No. 2011-205525

### SUMMARY OF THE INVENTION

### Technical Problem

In a system of the related art that addresses loss of alarms, the accuracy of detection of lost alarms is insufficient. For example, in a scheme for detecting a lost alarm on the basis of a sequence number as in Patent Literature 1, the last transmitted alarm cannot be retransmitted when the last transmitted alarm is lost. Hereinafter, a last alarm will be described with reference to FIGS. 10 and 11.

FIG. 10 is a sequence diagram of a case in which loss of an alarm is detected on the basis of a sequence number for each alarm.

A communication device 91 transmits an alarm with a sequence number #1 to a management device 92 (S91). Similarly, the communication device 91 performs transmission of an alarm with a sequence number #2 (S92) and transmission of an alarm with a sequence number #3 (S93). Here, it is assumed that the alarm with the sequence number #2 is lost.

Because the sequence number #2 is lost between the received sequence number #1 and the sequence number #3, the management device 92 requests the communication device 91 to retransmit the lost alarm with the sequence number #2 (S94). The communication device 91 retransmits the alarm with the sequence number #2 to the management device 92 according to the retransmission request (S95).

FIG. 11 is a sequence diagram of a case in which the last alarm is lost in the processing of FIG. 10. In this case, the management device 92 cannot identify the alarm with the sequence number #3 having not been received, from the alarms with the sequence numbers #1 and #2 having been received. Thus, the scheme for detecting a lost alarm on the basis of the sequence number does not provide sufficient accuracy for the lost alarm.

Therefore, a main object of the present invention is to propose a highly accurate scheme for addressing lost alarms.

### Means for Solving the Problem

In order to achieve the object, a lost alarm addressing system of the present invention has the following characteristics.

The present invention includes communication devices configured to transmit an alarm to a management device and transmit a number-of-alarms notification for notifying the number of transmitted alarms to the management device; and the management device configured to count the number of alarms received from each of the communication devices, collate the counted number of alarms with the number of alarms notified using the number-of-alarms notification, and cause the communication device to retransmit a lost alarm when the two numbers of alarms do not match.

This allows a lost alarm to be appropriately detected using a difference between the number of transmissions of alarms and the number of receptions of alarms, and thus, it is possible to propose a highly accurate scheme for addressing a lost alarm even when the alarm is the last alarm.

In the present invention, the management device causes, when the management device does not receive the number-of-alarms notification within a predetermined time after receiving the alarm from the communication device, the communication device to retransmit the lost number-of-alarms notification.

Thus, loss of a number-of-alarms notification for the last alarm can be detected early by providing a predetermined waiting time.

In the present invention, when the management device successively receives a plurality of number-of-alarms notifications from the communication device, the management device detects loss of an alarm between the successively received number-of-alarms notifications and causes the communication device to retransmit the lost alarm.

This allows the lost alarm between the received number-of-alarms notifications to be detected easily.

In the present invention, when the management device successively receives a plurality of the alarms from the communication devices, the management device detects loss of the number-of-alarms notification between the successively received alarms, and causes the communication device to retransmit the lost number-of-alarms notification.

This allows loss of the number-of-alarms notification between the received alarms to be detected easily.

In the present invention, the communication device transmits a plurality of alarms generated within a predetermined time to the management device, and transmits the number-of-alarms notification for notifying the number of alarms including the plurality of alarms to the management device after the predetermined time.

This suppresses an increase in traffic by reducing the number of transmissions of the number-of-alarms notification, as compared to a scheme for alternately transmitting one alarm and one number-of-alarms notification.

### Effects of the Invention

According to the present invention, it is possible to propose a highly accurate scheme for addressing lost alarms.

### BRIEF DESCRIPTION OF DRAWINGS

FIG. 1 is a configuration diagram of a monitoring system according to the present embodiment.

FIG. 2 is an illustrative diagram of processing of detecting a lost alarm in the monitoring system of FIG. 1 according to the embodiment.

FIG. 3 is a sequence diagram of a case in which a retransmission request is transmitted according to (Case 1) in the embodiment.

FIG. 4 is a sequence diagram of a case in which a retransmission request is transmitted according to (Case 2) in the embodiment.

FIG. 5 is a sequence diagram of a case in which a retransmission request is transmitted according to (Case 3) in the embodiment.

FIG. 6 is a sequence diagram of a case in which a retransmission request is transmitted according to (Case 4) in the embodiment.

FIG. 7 is a flowchart showing processing of a management device according to the embodiment.

FIG. 8 is a sequence diagram of a case in which the number of alarms corresponding to a plurality of alarms is collectively transmitted according to the embodiment.

FIG. 9 is a detailed configuration diagram of the monitoring system according to the embodiment.

FIG. 10 is a sequence diagram of a case in which loss of an alarm is detected on the basis of a sequence number for each alarm.

FIG. 11 is a sequence diagram of a case in which the last alarm is lost in the processing of FIG. 10.

### DESCRIPTION OF EMBODIMENTS

An embodiment of the present disclosure will be described below with reference to the drawings.

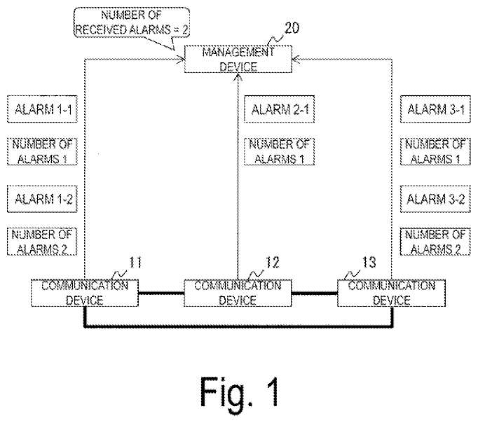

FIG. 1 is a configuration diagram of a monitoring system. A monitoring system (a lost alarm addressing system) has a configuration in which a management device 20, which is a monitoring side, and each of communication devices 11 to 13, which is a monitored side, are connected by a monitoring control network.

Each of these devices (the management device 20 and the communication devices 11 to 13) is configured as a computer including a central processing unit (CPU), a memory, a storage means (a storage unit) such as a hard disk, and a network interface.

The CPU executes a program (also referred to as an application or an app, which is an abbreviation therefor) read into the memory, and thus, the computer operates a control unit (control means) including various processing units.

The communication devices 11 to 13 are, for example, optical transmission devices such as wavelength division multiplexing (WDM) devices that are used in an optical transmission system. The communication devices 11 to 13 are connected by communication lines such as optical fibers (bold lines in FIG. 1). The communication devices 11 to 13 used in the optical transmission system insert (add) an optical signal from a client terminal (not shown) into an optical network or extract (drop) an optical signal from the optical network to the client terminal. Further, the communication devices 11 to 13 wavelength-multiplex the optical signal to be inserted into the optical network or amplify an optical signal of which a strength has been attenuated due to transmission line propagation.

The management device 20 is, for example, an operation system (OpS) that monitors and controls the optical transmission system (the communication devices 11 to 13) via a monitoring control network. The management device 20 receives various alarms (such as an alarm for notifying an abnormality in a communication line, an alarm for notifying device failures, and the like) transmitted from the communication devices 11 to 13, and transmits the content of the alarms to a network manager or the like.

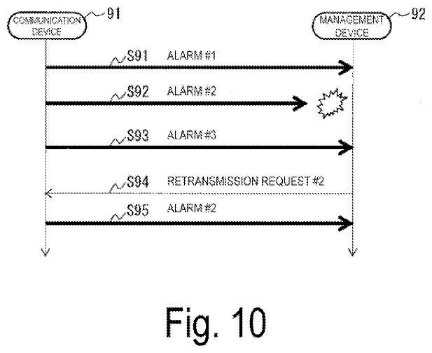

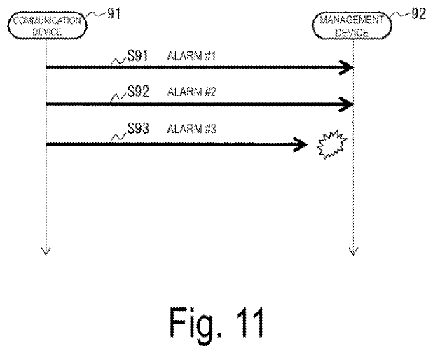

Here, the communication devices 11 to 13 in FIG. 1 also transmit a message for notifying the number of transmitted alarms (hereinafter, “number-of-alarms notification”) in addition to the alarm, to the management device 20, unlike a sequence number scheme for each alarm shown in FIGS. 10 and 11.

For example, focusing on the communication device 11, it is assumed that each of a first alarm 1-1 and a second alarm 1-2 has been transmitted. First, the number of alarms held in the communication device 11 (that is, transmitted to the management device 20) at a time point after the first alarm 1-1 is 1. Thus, the communication device 11 also transmits a number-of-alarms notification with the number of alarms “1” to the management device 20 after the transmission of the alarm 1-1.

Then, the number of alarms held in the communication device 11 at a time point after the second alarm 1-2 is 2, which is a total of the first alarm 1-1 and the second alarm 1-2. Thus, the communication device 11 also transmits a number-of-alarms notification with the number of alarms “2” to the management device 20 after the transmission of the alarm 1-2.

The management device 20 counts, as the number of received alarms, the number of alarms transmitted from each of the communication devices 11 to 13 (that is, separately for three devices). For example, focusing on the communication device 11, the management device 20 counts the number of received alarms=2 because the first alarm 1-1 and the second alarm 1-2 have each been transmitted.

The management device 20 compares the number of alarms “2” notified after the transmission of the alarm 1-2 with the counted number of received alarms “2” to confirm that loss of an alarm has not occurred, in other word, alarms have been successfully received when the numbers of alarms match.

While the above is a description focusing on the communication device 11, the management device 20 also compares the number of notified alarms with the counted number of received alarms to detect loss of an alarm for the communication devices 12 and 13.

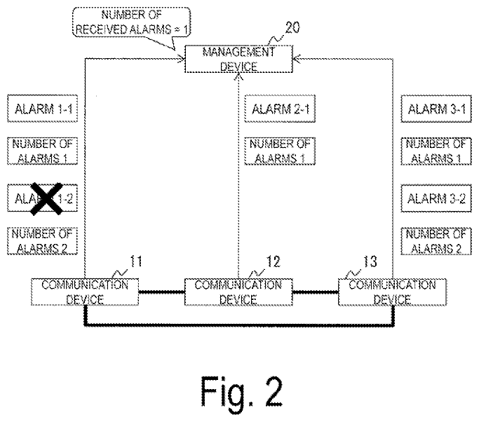

FIG. 2 is an illustrative diagram of processing of detecting a lost alarm in the monitoring system in FIG. 1. It is assumed that the first alarm 1-1 from the communication device 11 is not lost and only the second alarm 1-2 is lost, as indicated by a mark “x”. That is, the number of received alarms of the management device 20 remains “1”.

In this case, the management device 20 compares the last notified number of alarms “2” with the counted number of received alarms “1” to detect that loss of the alarm occurs because the numbers do not match. The management device 20 transmits a request for retransmission of the lost alarm 1-2 to the communication device 11, and as a result, the alarm 1-2 and the subsequent number-of-alarms notification “2” are retransmitted. The processing of detecting a lost alarm due to a mismatch between the number of alarms on the transmission side and the number of received alarms has been described.

The management device 20 may compare the number of alarms processed by the management device 20 after the reception (the number of processed alarms on the receiving side), in addition to the number of received alarms at the time of reception, with the number of transmitted alarms.

As a result, the management device 20 can detect an alarm that is received, but is lost due to internal processing therein.

The management device 20 may detect loss of the alarm and perform a retransmission request on the basis of at least one of cases listed below. An alarm from which the retransmission is to be performed is designated in the retransmission request.

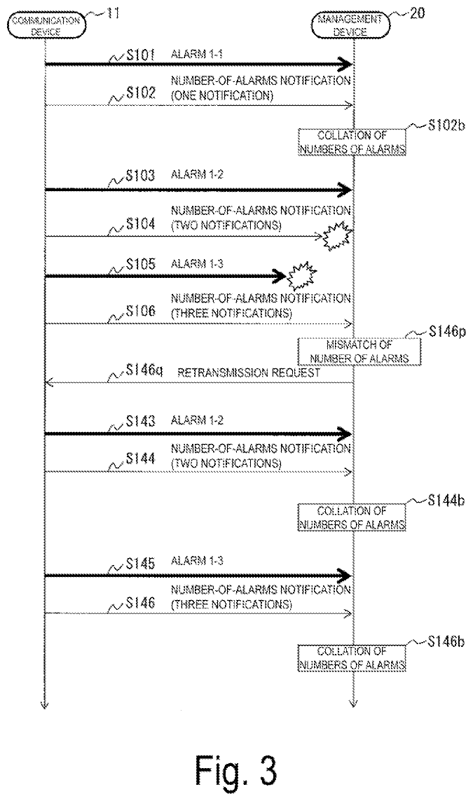

(Case 1) A case in which there is a mismatch between the number of alarms on the transmission side and the number of received alarms (as described above with reference to FIG. 2, and will be described below with reference to FIG. 3)

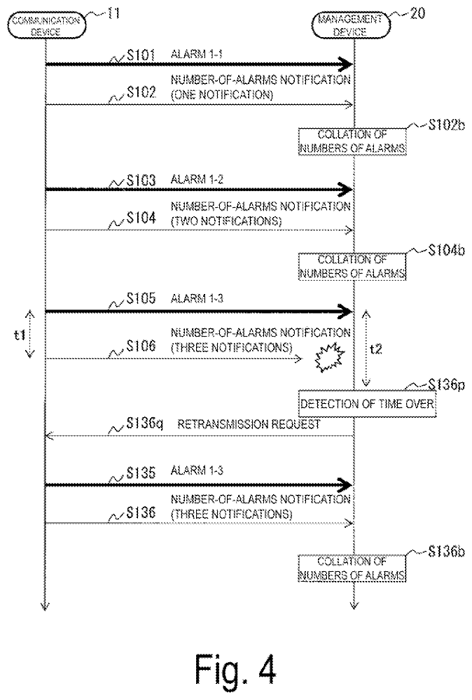

(Case 2) A case in which a number-of-alarms notification is not received within a predetermined time, which is defined in advance, after reception of an alarm (which will be described below with reference to FIG. 4).

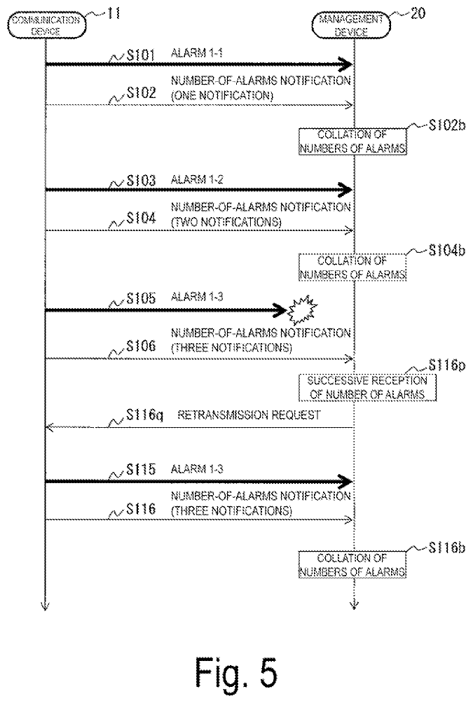

(Case 3) A case in which a number-of-alarms notification is received without the alarm received (which will be described below with reference to FIG. 5).

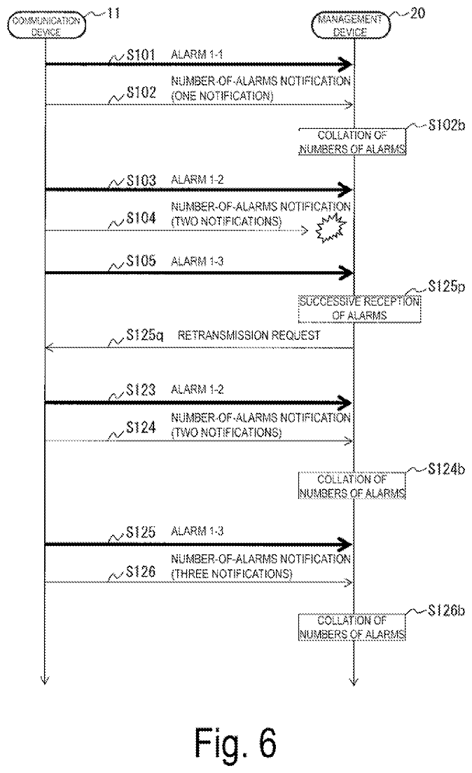

(Case 4) A case in which the next alarm is received without the number of alarms corresponding to the alarms received (which will be described below with reference to FIG. 6)

FIG. 3 is a sequence diagram of a case in which a retransmission request is transmitted according to (Case 1).

The communication device 11 transmits the alarm 1-1 to the management device 20 (S101), and also transmits a number-of-alarms notification for notifying the number-of-alarms notification=1 (S102). The management device 20 collates the number of received alarms=1 received in S101 with the number of alarms=1 in S102 and determines that no alarm is lost at a current time point because the numbers match (S102b).

The communication device 11 transmits the alarm 1-2 to the management device 20 (S103), and also transmits a number-of-alarms notification for notifying the number of alarms=2 (S104). However, the number-of-alarms notification is lost. Further, the communication device 11 transmits an alarm 1-3 to the management device 20 (S105) and also transmits a number-of-alarms notification for notifying the number of alarms=3 (S106). However, the alarm 1-3 is lost.

The management device 20 collates the number-of-alarms notification for notifying the number of received alarms=2 received in S101 and S103 with the number of alarms=3 in S106 and determines that loss of the alarm has occurred because the numbers do not match (S146p). Thus, the management device 20 transmits a request for retransmission of the alarm to the communication device 11 (S146q).

The communication device 11 receives the request for retransmission of the alarm and redoes the processing from transmission of the alarm 1-2 that has already been transmitted (retransmission of S103 is S143, retransmission of S104 is S144, retransmission of S105 is S145, and retransmission of S106 is S146).

The management device 20 also redoes the processing of collating the numbers of alarms each time the number-of-alarms notification is notified (S144b, S146b).

FIG. 4 is a sequence diagram of a case in which the retransmission request is transmitted according to (Case 2). First, as a predetermined time t2 that is a waiting time for transmission of the retransmission request, the same time (lx) as the waiting time t1 on the transmission side from the time of transmission of an alarm to the time of transmission of a number-of-alarms notification or 1.5 times the waiting time t1 is set in the management device 20 in advance. S101 to S106 are the same processes as in FIG. 3. Here, it is assumed that a third number-of-alarms notification (S106) is lost. The management device 20 activates a timer from a reception time of the alarm 1-3 (S105) and detects that the predetermined time t2 is over without the number-of-alarms notification (S106) received (S136p).

Thus, the management device 20 transmits a request for retransmission of the alarm to the communication device 11 (S136q). The communication device 11 receives the request for retransmission of the alarm, and redoes the processing from the transmission of the alarm 1-3 that has already been transmitted (retransmission of S105 is S135 and retransmission of S106 is S136). The management device 20 also redoes the processing of collating the numbers of alarms (S136b).

FIG. 5 is a sequence diagram of a case in which the retransmission request is transmitted according to (Case 3).

S101 to S106 are the same processing as in FIG. 3. Here, it is assumed that the alarm 1-3 is lost (S105). The management device 20 successively receives the number of alarms unlike the normal operation in which the alarm reception and the number-of-alarms notification reception alternately occur like “alarm reception, number-of-alarms notification reception, alarm reception, number-of-alarms notification reception, alarm reception . . . ”, thereby detecting that the management device 20 has received the number-of-alarms notification without receiving the alarm (S116p).

Thus, the management device 20 transmits a request for retransmission of the alarm to the communication device 11 (S116q). The communication device 11 receives the request for retransmission of the alarm and redoes the processing from the transmission of the alarm 1-3 that has already been transmitted (retransmission of S105 is S115 and retransmission of S106 is S116). The management device 20 also redoes the processing of collating the numbers of alarms (S116b).

FIG. 6 is a sequence diagram of a case in which the retransmission request is transmitted according to (Case 4).

S101 to S106 are the same processes as in FIG. 3. Here, it is assumed that a second number-of-alarms notification (S104) is lost. The management device 20 successively receives alarms unlike the normal operation in which the alarm reception and the number-of-alarms notification reception alternately occur, thereby detecting that the management device 20 has received the next alarm without receiving the number of alarms corresponding to the alarms (S125p). Thus, the management device 20 transmits a request for retransmission of the alarm to the communication device 11 (S125q). The communication device 11 receives the request for retransmission of the alarm, and redoes the processing from the transmission of the alarm 1-2 that has already been transmitted (retransmission of S103 is S123, retransmission of S104 is S124, and retransmission of S105 is S125). The management device 20 also redoes the processing of collating the numbers of alarms (S124b).

The communication device 11 also transmits a number-of-alarms notification for notifying the number of alarms=3 after the communication device 11 transmits the alarm 1-3 in S125 (S126). The management device 20 performs the processing of collating the numbers of alarms (S126b).

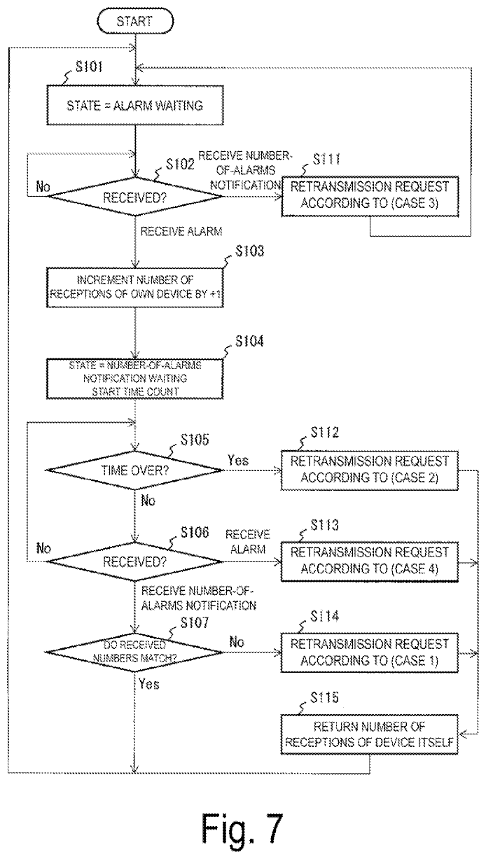

FIG. 7 is a flowchart showing processing of the management device.

Processing at the time of normal reception (S101 to S107) will be described first, and then, processing at the time of occurrence of loss in each of (Case 1) to (Case 4) will be described (S111 to S115).

The management device 20 sets its current state to alarm waiting (S101) and waits for reception of a message from the communication device 11 (S102: No). When the received message is an alarm (S102; alarm reception), the management device 20 increments the number of received alarms for the alarm by 1 (S103), changes the current state to number-of-alarms notification waiting, and starts time counting (S104).

When the management device 20 receives the number-of-alarms notification from the communication device 11 (S106; number-of-alarms notification reception) before the time counted in S104 is over (S105: No), the management device 20 performs comparison to check whether the number of alarms on the transmission side included in the number-of-alarms notification matches the number of received alarms incremented in S103 (S107). When the numbers of alarms match (S107: Yes), the management device 20 returns the processing to S101 in order to prepare for the next alarm reception.

Next, the processing at the time of occurrence of loss will be described.

When the management device 20 has received the number-of-alarms notification without receiving the alarm (S102; number-of-alarms notification reception), the management device 20 transmits a retransmission request to the communication device 11 according to (Case 3) (S111).

When the management device 20 does not receive the number-of-alarms notification within a predetermined time defined in advance after the reception of the alarm (S105: Yes), the management device 20 transmits a retransmission request to the communication device 11 according to (Case 2) (S112).

When the management device 20 receives the next alarm without receiving the number-of-alarms notification corresponding to the alarm (S106; alarm reception), the management device 20 transmits a retransmission request to the communication device 11 according to (Case 4) (S113).

When there is a mismatch between the number of the alarms on the transmission side and the number of received alarms (S107: No), the management device 20 transmits a retransmission request to the communication device 11 according to (Case 1) (S114).

The alarm incremented in S103 is retransmitted after the respective retransmission requests of S112 to S114, and thus, processing is required to return the number of received alarms to that before incrementing in S103.

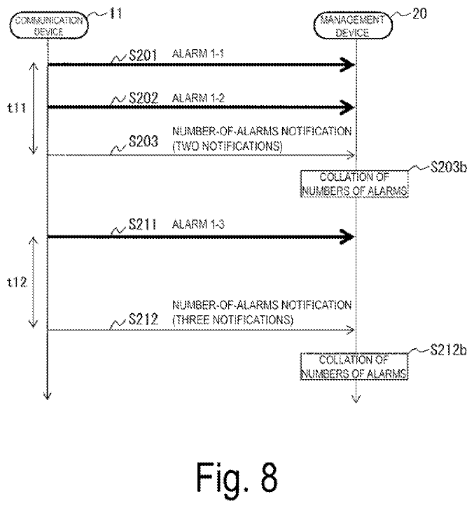

FIG. 8 is a sequence diagram for a case in which a number-of-alarms notification corresponding to a plurality of alarms is collectively transmitted.

In the (Case 4), it is assumed that the request for retransmission is issued when the next alarm is received without the number-of-alarms notification corresponding to the alarm received (that is, when an alarm is successively received). Alarms generated within a waiting time t11 on the transmission side may be collectively (successively) transmitted from the communication device 11 to the management device 20, as shown in FIG. 8, instead of applying (Case 4). After the waiting time t11, the communication device 11 may transmit, as one number-of-alarms notification, the number of alarms on the transmission side including the number of plurality of alarms generated in the waiting time t11 to the management device 20.

For example, the communication device 11 transmits two alarms 1-1 and 1-2 in the waiting time t11 (S201 and S202), and then, collectively performs a number-of-alarms notification for the two alarms at one time (S203). The management device 20 recognizes that (Case 1) does not occur because collation (S203b) between numbers of the two alarms has been performed successfully. Similarly, the communication device 11 transmits one alarm 1-3 in a waiting time t12 (S211), and then, transmits a number-of-alarms notification for a total of three alarms (S212). The management device 20 recognizes that (Case 1) does not occur because collation (S212b) between the numbers of three alarms has been performed successfully.

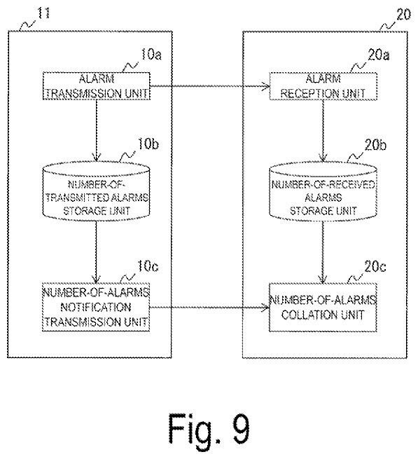

FIG. 9 is a detailed configuration diagram of the monitoring system of FIG. 1.

Each communication device such as the communication device 11 includes an alarm transmission unit 10a that transmits an alarm, a number-of-transmitted alarms storage unit 10b that stores the number of transmitted alarms, and a number-of-alarms notification transmission unit 10c that notifies the number of transmitted alarms.

The management device 20 includes an alarm reception unit 20a that receives an alarm, a number-of-received alarms storage unit 20b that stores the number of received alarms, and a numbers-of-alarms collation unit 20c that collates the number of received alarms in the number-of-received alarms storage unit 20b with the number of alarms included in the number-of-alarms notification received from the number-of-alarms notification transmission unit 10c.

The monitoring system that prevents, even when loss of an alarm transmitted from the communication devices 11 to 13 to the management device 20 occurs, a network manager from failing to acquire the alarm due to the loss has been described in the embodiment described above.

The communication devices 11 to 13 (the alarm transmission side) transmit a number-of-alarms notification for notifying the number of alarms currently held by each of communication devices 11 to 13 to the management device 20 after the transmission of the alarm. The management device 20 (the alarm reception side) collates the number of alarms held by the management device 20 with the number of transmitted alarms.

This allows loss of the alarm to be detected when the numbers of alarms do not match as a result of the collation. Therefore, failure of the acquisition of the alarm, even when the alarm is the last alarm, can be prevented by causing each of the communication devices 11 to 13 to retransmit the lost alarm. Thus, a network manager can construct a highly reliable network without overlooking occurrence of failure.

In the embodiment, the management device 20 according to the invention manages three communication devices 11 to 13 as shown in FIG. 1, but is not limited to this number or configuration thereof. Further, the invention can be achieved by a program causing hardware resources of a general computer to be operated as each means of the communication devices 11 to 13 and the management device 20. The program may also be distributed over a communications line, or may be recorded and distributed on a recording medium such as CD-ROM.

### REFERENCE SIGNS LIST

11 to 13 Communication device
20 Management device

1. A lost alarm addressing system comprising:
communication devices configured to transmit an alarm to a management device and transmit a number-of-alarms notification for notifying a number of transmitted alarms to the management device; and
wherein the management device is configured to (i) count a number of alarms received from each of the communication devices, (ii) collate the counted number of alarms with the number of alarms notified using the number-of-alarms notification, and (iii) cause, based on the counted number and the number of alarms notified not matching, the communication device to retransmit a lost alarm.

2. The lost alarm addressing system according to claim 1, wherein the management device is configured to cause, based on the management device not receiving the number-of-alarms notification within a predetermined time after receiving the alarm from the communication device, the communication device to retransmit a lost number-of-alarms notification.

3. The lost alarm addressing system according to claim 1, wherein, when the management device successively receives a plurality of the number-of-alarms notifications from the communication device, the management device is configured to detect loss of an alarm between the successively received number-of-alarms notifications and cause the communication device to retransmit the lost alarm.

4. The lost alarm addressing system according to claim 1, wherein, when the management device successively receives a plurality of the alarms from the communication devices, the management device is configured to detect loss of the number-of-alarms notification between the successively received alarms, and cause the communication device to retransmit the lost number-of-alarms notification.

5. The lost alarm addressing system according to claim 1, wherein the communication device is configured to transmit a plurality of the alarms generated within a predetermined time to the management device, and transmit, to the management device, the number-of-alarms notification for notifying the number of alarms including a plurality of alarms after the predetermined time.

6. A lost alarm addressing method executed by a lost alarm addressing system having a configuration in which communication devices and a management device are connected by a network, the method comprising:
transmitting, by the communication devices, an alarm to the management device;
transmitting, to the management device, a number-of-alarms notification for notifying the number of transmitted alarms;
counting, by the management device, a number of alarms received from each of the communication devices;
collating the counted number of alarms with the number of alarms notified using the number-of-alarms notification; and
causing, based on the counted number and the number of alarms notified not matching, the communication device to retransmit a lost alarm.

7. The lost alarm addressing method according to claim 6, further comprising causing, based on the management device not receiving the number-of-alarms notification within a predetermined time after receiving the alarm from the communication device, the communication device to retransmit a lost number-of-alarms notification.

8. The lost alarm addressing method according to claim 6, further comprising:
when the management device successively receives a plurality of the number-of-alarms notifications from the communication device, detecting loss of an alarm between the successively received number-of-alarms notifications and causing the communication device to retransmit the lost alarm.

9. The lost alarm addressing method according to claim 6, further comprising:
when the management device successively receives a plurality of the alarms from the communication devices, detecting loss of the number-of-alarms notification between the successively received alarms and causing the communication device to retransmit the lost number-of-alarms notification.

10. The lost alarm addressing method according to claim 6, further comprising:
transmitting, to the management device, a plurality of the alarms generated within a predetermined time and the number-of-alarms notification for notifying the number of alarms including a plurality of alarms after the predetermined time.
